(19) United States
(12) Patent Application Publication
(10) Pub. No.: US 2017/0144800 A1
(43) Pub. Date: May 25, 2017

(54) FILM BAG

(71) Applicant: MONDI CONSUMER PACKAGING TECHNOLOGIES GMBH, GRONAU (DE)

(72) Inventors: MICHELE LUCCHESE, MAINZ (DE); JENS KOESTERS, WALLENHORST (DE); MATTHIAS PERICK, AHAUS-ALSTAETTE (DE); IMMO SANDER, WIESBADEN (DE)

(21) Appl. No.: 15/348,711

(22) Filed: Nov. 10, 2016

(30) Foreign Application Priority Data
Nov. 13, 2015 (EP) 15194573.0

(51) Int. Cl. B65D 33/00; G09F 3/02; B65D 75/58; G09F 3/08; B65D 75/00; B65D 75/56

(52) U.S. Cl. CPC B65D 33/004; B65D 75/008; B65D 75/566; B65D 75/5883; G09F 3/08; G09F 3/02; G09F 2003/0222; G09F 2003/0251; G09F 2003/0272

(57) ABSTRACT

A bag has front and back face panels formed of a body film and each having two generally parallel and normally vertical side edges bridging ends of respective upper and lower edges, respective longitudinal side welds fixing the side edges of the front panel to the side edges of the back panel, a separate piece of label film different from the body film, covering a mid portion of one of the face panels between the respective longitudinal edges, and spaced downward from the upper edge of the one face panel and upward from the lower edge of the one face panel, and structure at the longitudinal edges holding the piece of label film on the one face panel without surface bonding of the piece of label film to the one face panel between the respective longitudinal edges.

### FIELD OF THE INVENTION

The present invention relates to a bag made of film. More particularly this invention concerns such a bag provided with a separate printing-carrying label.

### BACKGROUND OF THE INVENTION

The present invention relates to a film bag, in particular a film bag with a body and with an additional piece of label film furnished with printing that is carried on an outside surface of the body. The body has at least two face panels opposite one another made from body film that are delimited by an upper bag edge, a lower bag edge and side edges and the piece of label film and the body film are not fully attached to one another, that is not bonded together in full surface contact. The present invention therefore relates to a film bag that is formed of at least two pieces of film that are not fully attached to one another.

Such a construction is often used, according to the state of the art, in order to form a sealed body made from a thin film that can be sealed hermetically to contain some fluent material such as liquid or particles. The body forms a closed or closable interior space, and the separate piece of body film is used for stiffening and support of the structure. Relevant film bags are known, for example, from DE 19,60,577, EP 1,053,951, GB 1,391,734, US 2003/0002755, EP 1 714 892 and WO 2009/131514.

For the known designs, it is essential that the additional piece of label film is stiff and in particular also support the bottom of the body.

In the embodiments described, the body can be partially separated from the separate piece of label film or the supporting structure formed by it. The separate piece of label film or the supporting structure formed by it result in a very high cost of materials, however, which is why the known designs are also unfavorable from an ecological point of view, even if the sealed body can be made from a comparably thin film material. In addition, the clearly visible two-part construction is less aesthetically pleasing from the consumer's point of view.

Conventional film bags are used in practice as mass-produced items. The typical structure of such a film bag is known for example from EP 2 032 454 and EP 2 364 848.

A laminate with an inner film made from polyethylene (PE) and an outer film based on polyethylene terephthalate (PET) or biaxially oriented polypropylene (BOPP) is often used as the material for the bag body. A printed layer is applied inside on the contact surface, either on the outer film or the inner film in such a laminate before adhesion of the inner film to the outer film and is then visible through the transparent outer film.

Such film bags are characterized by a particularly high quality appearance and good functional characteristics. However, owing to the lamination of the different polymer materials, fully sorted plastic recycling is not possible, which is why such film bags are at best burned after their use as disposable items.

Plastic waste that can be separated into particles each formed by a monocomponent resin through shredding is in practice often separated by specialized sorting equipment according to its specific weight or density, using both dynamic separation of the groups in a flow and static processes.

A particularly simple method of separation is possible if plastic particles put into a separation tank filled with water, so that the particles that are lighter than water float and the heavier particles sink. Such facilities are therefore also referred to as float-sink tanks and can separate polyethylene terephthalate (PET) or polyvinyl chloride (PVC) with a density greater than 1 g/cm³, for example, from standard polyolefins such as polyethylene (PE) or polypropylene (PP) that—at least in the standard version—have a density of less than 1 g/cm³. A method and a device for the separation of particles of different plastics into homogeneous groups is known, for example, from U.S. Pat. No. 5,246,115.

In the field of film bags, bags formed of monocomponent resins printed on their exterior are also known for certain use cases, for example for holding road salt. However, such designs are considered by a user to be lower quality and generally have relatively poor functional characteristics. Printing applied to the exterior is not protected against wear, meaning that it is therefore also not possible to achieve a high quality appearance. The job of separating layer materials made from different plastics into their component parts either through the use of solvents or mechanically is described in DE 41 05 949, DE 92 13 804, and DE 93 01 234.

Other procedures for the disassembly and cleaner separation of composite materials made from plastic are known from EP 801,163, EP 1,036,596, US 2004/0129372 and EP 2,371,508, where significant process effort is required in each case in order to achieve the separation of the materials through physical and/or chemical processing of the products to be recycled.

### OBJECTS OF THE INVENTION

It is therefore an object of the present invention to provide an improved film bag.

Another object is the provision of such an improved film bag that overcomes the above-given disadvantages, in particular that has a simple structure and good functional characteristics and can be relatively easily recycled.

### SUMMARY OF THE INVENTION

A bag has according to the invention front and back face panels formed of a body film and each having two generally parallel and normally vertical side edges bridging ends of respective upper and lower edges, respective longitudinal side welds fixing the side edges of the front panel to the side edges of the back panel, a separate piece of label film different from the body film, covering a mid portion of one of the face panels between the respective longitudinal edges, and spaced downward from the upper edge of the one face panel and upward from the lower edge of the one face panel, and structure at the longitudinal edges holding the piece of label film on the one face panel without surface bonding of the piece of label film to the one face panel between the respective longitudinal edges. The label film has a thickness between 20 μm and 170 μm, and the label film and body films have respective densities that differ by at least 0.02 g/cm³, or it has a thickness between 20 μm and 100 μm, and a ratio between a thickness of the body film and a thickness of the label film is larger than 3:2.

According to a first variant the invention, the purpose, or at least the primary purpose, of the additional piece of label film is not to reinforce the body but to accommodate printing, while the body itself is preferably not printed. The separate film section, which only covers part of the surface of the front panel, is sufficient to accommodate the information that is relevant to a user, an individual design or other aspects of product held in the film bag.

Since the piece of label film and the body film forming at least the front panel have a different density with a difference of at least 0.02 g/cm³ and are not fully attached to one another, the different materials can also be separated from one another using a suitable automated process after shredding and can be disposed of, recycled or otherwise utilized separately.

According to a second variant of the invention in which the piece of label film has a thickness of between 20 μm and 100 μm, and that the ratio of the thickness of the body film to the thickness of the piece of label film is greater than 3:2, and in particular greater than 2:1.

Thanks to these characteristics, separation for recycling is also possible using air classification based on the different material thicknesses after shredding of the film bag. Particles of the material from the piece of label film, which is significantly thinner, and preferably thinner by a factor of 2, can easily be removed from the particles of shredded film bag using air classification. Printing is also applied only to the piece of label film within the second variant described so that the group formed by the body film during recycling can be reused with no problem.

A design of a film bag for which a different density according to the first variant and a different material thickness according to the second variant is envisaged between the body film and the piece of label film is particularly preferred. A film bag that can be recycled in a variety of ways is then formed, so that for such a particularly preferred design, the exact recycling process does not need to be specified in advance.

In the context of the invention, the body alone is sufficient to give the film bag the necessary stability. When dealing with a stand-up pouch, the body is preferably self-supporting even without the additional piece of label film. In the context of the invention, the body can be formed by the two face panels alone, in the manner of a sachet. Alternatively, side folds and/or a bottom fold can also be provided that are then preferably formed of the body film so that the entire body consists of the body film.

According to the invention, the body film and the separate piece of label film can be separated from one another according to the first variant described using the difference in density. In particular, the body as the main component can be readily recycled while disposal of the smaller piece of label film can be accepted.

Against this background, it is beneficial if the use of material for the additional piece of label film is comparably low. The piece of label film preferably covers less than 50% of the surface of the underlying front panel or the underlying face panels. According to the invention, the thickness is between 20 μm and 170 μm, and the thickness is preferably less than 120 μm, in particular less than 60 μm. The design of the piece of label film with a low thickness of between 30 μm and 60 μm, for example, is possible because the piece of label film does not fulfil a structural function, or at most fulfils a supporting structural function in the context of the invention.

As previously described, the piece of label film is spaced from the upper bag edge and from the lower bag edge. The gap is generally at least 1 cm, preferably at least 3 cm, particularly preferably at least 5 cm.

In order to allow for good recycling of the body, this can be made from a monocomponent material. Polyolefins such as polyethylene (PE) or polypropylene (PP) are preferred. The body film is then labeled as single-origin in particular if it can be classified according to the German Ordinance of the Avoidance and Recovery of Packaging Waste (Packaging Ordinance—VerpackV) according to appendix IV, in which recycling number 02 HDPE (high density polyethylene), recycling number 04 LDPE (low density polyethylene) and recycling number 05 PP (polypropylene) are allocated, for example. Depending on the intended use, however, polyethylenes or polypropylenes with differing densities can be used as a blend or in a multilayer body film.

It is important to take into account the fact that the body with its face panels is preferably shaped and welded using thermal welds. For a multilayer design of the body film, a weldable inner layer can also be provided that can easily be melted and that allows for good sealing, while an exterior opposite it is not compromised by welding. To this end, the body film can, for example, be coextruded in multiple layers, and various types and/or blends of either polypropylene or polyethylene can be used for the individual layers.

According to the invention, the additional piece of label film and the body film are not fully attached to one another. Preferably, large unattached areas remain so that the particles resulting from shredding can then be fully separated from one another. Preferably, there are large unattached areas where the additional piece of label film is located and that have a square area of at least 10 cm². Preferably, only a small portion of the area of the piece of label film of, for example, less than 10%, preferably less than 5%, is attached to the body film. As explained in detail below, the piece of label film and the body film can also only be attached to one another through positive locking so that complete separation is then actually possible with sufficient shredding.

Unlike for a simple label, the piece of label film preferably covers the full width between the side edges on at least one of the face panels. At the side edges, the piece of label film can be attached to the side welds in a variety of ways or end at the welds. At least, the piece of label film then stretches across the associated front panel between the side welds. The piece of label film is preferably not attached to the associated front panel between the side edges thus welded.

In the context of the invention, the piece of label film can simply be provided on one front panel, which can in principle be sufficient for labeling and marking. Preferably, however, the piece of label film stretches across both face panels and thus forms a sort of sleeve. It is therefore also within the context of the invention to form a circumferentially sealed sleeve.

The piece of label film can be attached in a simple manner to the previously described longitudinal welds that run along the side edges. If a suitable material is chosen, the inner side of the piece of label film can be fused with the exterior of the face panels. With a tight seal, the areas thus attached can no longer be separated, meaning that these comparatively small sections can no longer be disposed of separately. The same applies if the body film and the piece of label film are attached with a non-soluble adhesive. Against this background, it is envisaged that, with permanent sealing, the piece of label film is not printed in the welded area. As described below, the difference in density according to the invention can be achieved through the use of a fundamentally different material to the material forming the body film or additional filler materials. It is in principle therefore also possible for the body film and the separate piece of label film to both be made from materials that can be recycled together. It is thus possible, for example, to form the body film and the separate piece of label film from polypropylene, and the difference in density according to the invention is achieved through the use of filler material and/or different types of polypropylene. If the piece of label film is then not printed in the welded area then this section can also be recycled with the body film, and no adverse effects are then to be feared from the printing ink.

Alternatively, the piece of label film can be attached to the body or to the body film using positive locking. It is thus possible, for example, to form slits on the longitudinal welds and then to run the separate piece of label film through these slits in the form of a circumferentially sealed sleeve. The materials can then be fully separated from one another when the film bag is shredded. Positive locking can alternatively be achieved by the body having a circumferential necking area at the height of the piece of label film so that a circumferentially sealed piece of label film in the form of a sleeve is then held by the shape of the body alone.

Furthermore, there is the option of providing the body film with openings on the longitudinal welds, and an inner side of the piece of label film can then be welded or, where applicable, adhered to itself through these openings. In the context of such a design, the design of the piece of label film as a circumferential sleeve is optional. It can also be envisaged, for example, that the piece of label film is predominantly arranged on one of the two face panels and only overlaps with the side edges at its ends in order to then be attached to itself through openings in the longitudinal welds in the manner described.

Likewise, a front and back piece of a circumferential piece of label film can be attached to one another through these openings. The unattached outer ends of the film piece can thereby also extend beyond the side edges of the body film.

In the context of the invention, the body film and the piece of label film can be mechanically separated based on the different densities. In addition, however, it can also be envisaged that the separation is done by a user so that the different films are disposed of separately from the outset. Subsequent mechanical separation can thus be omitted. In addition, the ecological benefits of the invention are thus immediately visible to the user.

For a firmly bonded connection as a result of heat sealing or adhesive, this connection can be pulled apart by a user so that a so-called peelable connection is provided. Alternatively, when attaching the piece of label film in the area of the side edges, tear lines can be formed directly on the side edges at which the majority of the piece of label film can be torn away from the body. Only small remnants of the piece of label film then remain at the side edges at which no material separation is then possible.

As already described above, the film bag is preferably a film bag so that the body is then welded in order to form airtight packaging. Such a film bag in the form of a film bag can also be provided with a resealable closure. This can be a zip or slider closure, for example, or a capped pour spout. The corresponding elements can be manufactured of the same material as the body or can be designed such that they separate themselves from the body film during shredding or remain behind as residual material.

The body film preferably has a thickness of between 125 μm and 250 μm, preferably between 150 μm and 220 μm. For the preferred polyolefins, this results in a density that is typically between 0.89 g/cm³ and 0.95 g/cm³ so that the body film in the context of the invention then preferably has a lower density than the piece of label film.

According to the invention, the difference in density is at least 0.02 g/cm³, preferably at least 0.05 g/cm³.

The density of the piece of label film is generally between 0.91 g/cm³ and 1.20 g/cm³. Particularly preferably, the density of the piece of label film is greater than 1 g/cm³ and in particular greater than 1.02 g/cm³, so that separation from the body film in a particular simple manner in a water bath is possible. While the body film particles float, the particles from the piece of label film with a density greater than 1 g/cm³ sink after shredding, meaning that separation can be done in a simple water tank. A density of more than 1 g/cm³ can be achieved in particular through the use of polyethylene terephthalate in at least one layer of the piece of label film.

The piece of label film is preferably made from a multilayer laminate, and the print can then also protected on an interior interface between the layers. The piece of label film preferably has a weldable layer made from polyolefin toward the body and an outer layer of polyethylene terephthalate on its opposite outer side. The proportions of the different polymers should then preferably be chosen such that the overall density of the piece of label film is greater than 1 g/cm³. In addition, it is also possible to increase the density of the piece of label film through the addition of filler materials such as CaCO₃ or other particles.

Even if the piece of label film is formed of a multilayer laminate, designs in which the sealed areas between the piece of label film and the body film can be recycled together with the body film are possible. To this end, the laminate only has the weldable layer at the edges at which sealing with the body occurs. This may include an outer layer, made from polyethylene terephthalate (PET) for example, being omitted or at least not attached in the laminate. To this end, a non-adhesive can be provided where welds will subsequently be formed that prevents the outer layer from attaching to the weldable layer. Alternatively, it is also possible to omit the laminating adhesive there.

The measures described make it possible to achieve a monocomponent connection at heat welds that are subsequently formed that can be disposed of with the body film. The sections of the outer layer that are not attached can optionally remain on the laminate or can be separated using suitable measures.

In the context of such a design, similar polymers to those used for the body film are then taken into consideration for the piece of label film—as previously described—and the difference in density according to the invention is achieved through the addition of filler materials.

### BRIEF DESCRIPTION OF THE DRAWING

The above and other objects, features, and advantages will become more readily apparent from the following description, reference being made to the accompanying drawing in which:

FIG. 1 is a front view of a film bag having a body made from a body film and a separate piece of label film;

FIG. 2 is a side view of the film bag according to FIG. 1;

FIGS. 3 and 4 are front views of alternative designs for the film bag of the is invention;

FIG. 5 is a horizontal section through the bag of this invention;

FIG. 6 is a large-scale view of a detail of FIG. 5; and

FIG. 7 is a large-scale view of a detail of the invention.

### SPECIFIC DESCRIPTION OF THE INVENTION

FIG. 1 shows a hermetically sealed film bag with a self-supporting body 1 having identical front and back face panels 2 opposite one another and each formed of a body film. An unillustrated folded floor panel also of the body film closes the bottom of the body 1 and allows the bag to stand as illustrated. The face panels 2 each have an upper bag edge, a lower bag edge and two normally vertically and longitudinally extending side edges extending between outer ends of the respective upper and lower edges. The face panels 2 are welded together circumferentially to one another, and in particular has longitudinal welds 3 running along the side edges. According to this embodiment, the two face panels 1 are welded together at one upper corner and there form a stamped-out handle 4, and at the other upper corner they are provided with a reclosable spout 5.

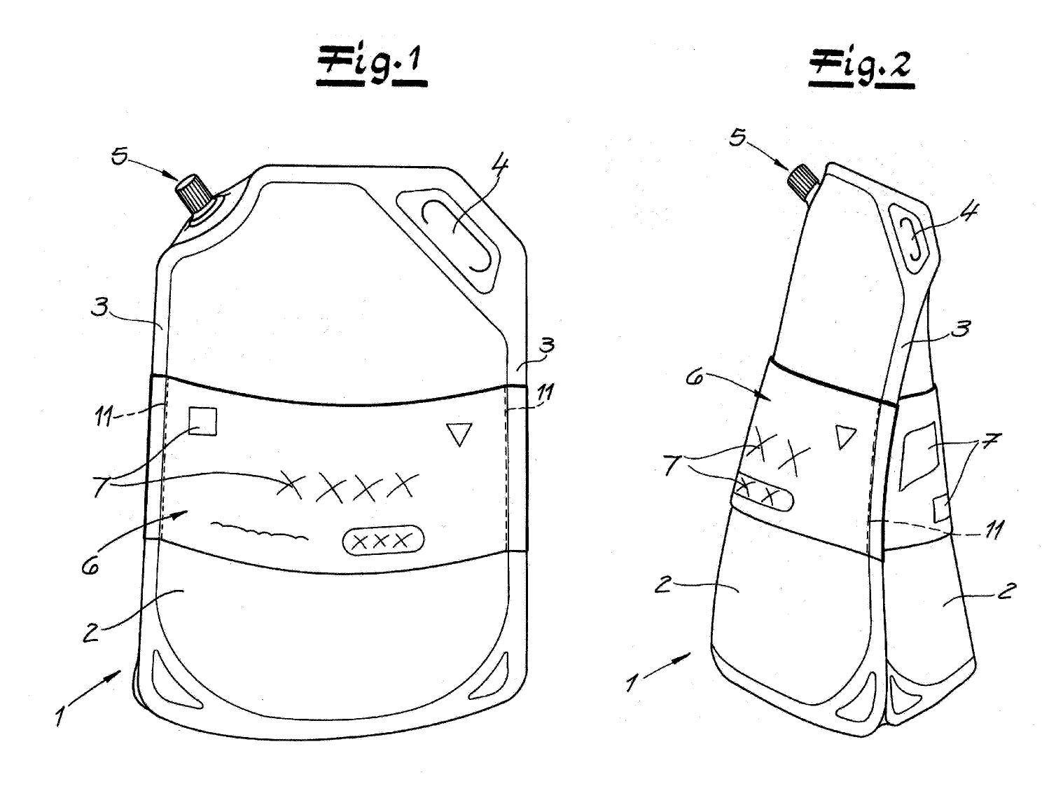

According to the invention, the film bag has a piece 6 of label film carrying printing that is only attached to the body film forming the face panels 2 at the longitudinal welds 3. In other words, the piece 5 engages the face panel 2 between the edge welds 3, but is not bonded, adhered, or otherwise affixed to it except at the welds 3. One such piece 6 of label film is provided on each of the face panels 2 according to FIG. 2 and forms a type of sleeve.

The body 1 itself is not printed and can be either transparent, translucent or colored in a single color. All printing 7 formed by markings and information is applied to the piece 6 of label film. While the printing 7 can be printed on the separate piece 6 of label film in particularly high quality, no ink is applied to the body 1, which is beneficial with regard to both manufacturing and recycling.

During mechanical shredding, the face panels 2 on the one hand and the piece 6 of label film on the other hand form separate particles since the piece 6 of label film is not attached to the underlying front panel 2 between the longitudinal welds 3. Only at the longitudinal welds 3 can the body film forming the face panels 2 not be separated from the piece 6 of label film. Thus only a tiny fraction of the label film will be inseparable from the body film when the bag is comminuted.

According to the invention, there is an upper gap between the piece 6 of label film and the upper bag edge and a lower gap between the piece 6 of label film and the lower bag edge that are each generally at least 1 cm, preferably at least 5 cm wide, measured longitudinally parallel to the side-edge welds 3. In addition, the piece of label film only has a thickness of between 20 μm and 170 μm, preferably between 30 mm and 60 μm, so that relative little material is required for the piece 6 of label film.

Multilayered laminated films in which the print is located in the interior and that are preferably also made from different materials are particularly suitable for the provision of a high quality print 7. Owing to the different materials and owing to the ink of the print 7, reprocessing through recycling is not possible or is only possible to a limited extent, which is why such materials are often only burnt as fuel. In the context of the invention, due to the comparatively thin piece 6 of label film that only stretches over part of the body 3 the proportion of such material that is not recyclable or is difficult to recycle is reduced.

Furthermore according to the invention the body film and the label film have different densities with a difference of at least 0.02 g/cm³. The materials can therefore be separated from one another using a suitable fluid technique. In the simplest case, separation can occur in a liquid bath thanks to the different densities. If, for example, the body film has a density greater than 1 g/cm³, which is the density of water, and the piece of label film has a density greater than 1 g/cm³ according to a preferred design of the invention, separation can occur in a simple water bath using a float-sink process.

Alternatively, separation can also be done by air classification with an air stream so that the separation threshold with regard to the density can easily be varied to a certain extent.

Depending on the procedure, air classification is also possible regardless of the different densities if the body film and the piece 6 of label film have thicknesses that differ significantly from one another.

Against this background, it is also envisaged in the context of the embodiment that the piece 6 of label film is on at least one of the face panels spaced from the upper edge and from the lower edge, and the piece 6 of label film, with a thickness of between 20 μm and 100 μm, is significantly thinner than the body film. The ratio of the thickness of the body film to the thickness of the piece 6 of label film is thereby appropriately greater than 3:2, in particular greater than 2:1, with the label film being the thinner film.

While the body film forming the body 1 is preferably a monocomponent film, the label film is preferably a multilayer laminate.

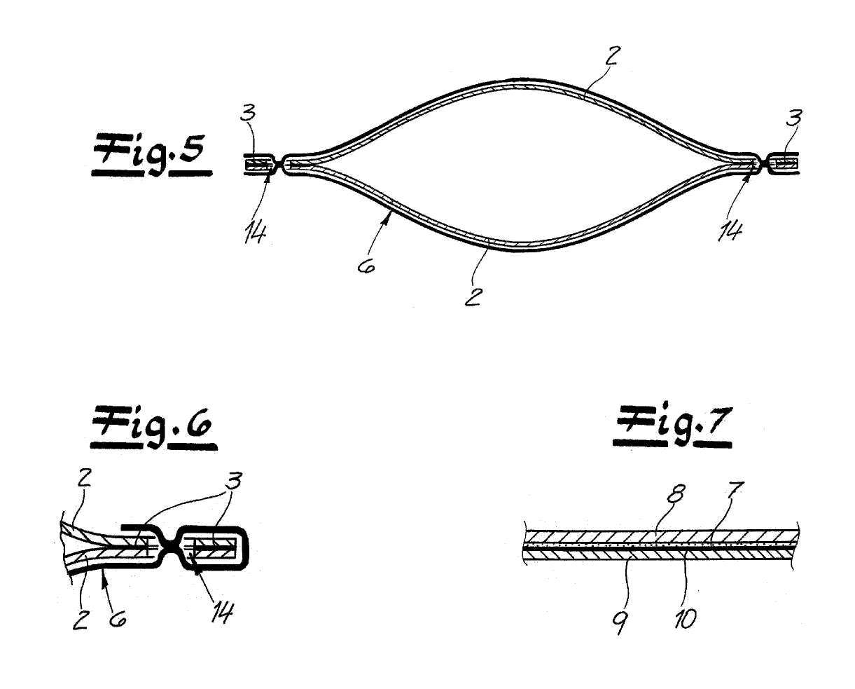

FIG. 7 shows an example of a preferred layer structure where the label film has an outer layer 8 made from PET toward the exterior of the bag and a weldable inner layer 9 made from polyethylene on the opposite side. According to FIG. 7, the print 7 is located on the inside on the outer layer 8, and the outer layer 8 and the weldable layer 9 are attached to one another using a laminating adhesive 10, for example a 2-part PUR adhesive.

For the embodiment in FIG. 1, the piece 6 of label film that runs across the two face panels 2 is incorporated into the longitudinal welds 3 and is firmly welded to the body 1 there. The thermoplastic inner layer 9 of the label film being easily welded to the thermoplastic and normally monocomponent body film.

Immediately adjacent the longitudinal welds 3, the piece 6 of label film has tear lines 11 that are generated with a laser or can be realized as rows of perforations. At least a majority of the piece 6 of label film can thus be torn off manually from the body 1 along the tear lines 11 by the user so that the user can then dispose of the piece separately from the outset, or simply remove it to unencumber the package from advertising. This results in improved separation if the film bag is not subsequently shredded for recycling. In addition, a user can also recognize the ecological benefits of the film bag according to the invention immediately.

Since the print is limited to the separate piece 6 of label film in the context of the invention, easy adaptation for a variety of contents, marketing areas or similar is also possible.

According to FIG. 1, some attached areas in which the piece 6 of label film and the body 1 are still attached remain after shredding. Taking this into account, complete separating can be made possible if the piece 6 of label film is welded at the longitudinal welds 3 in a separable manner.

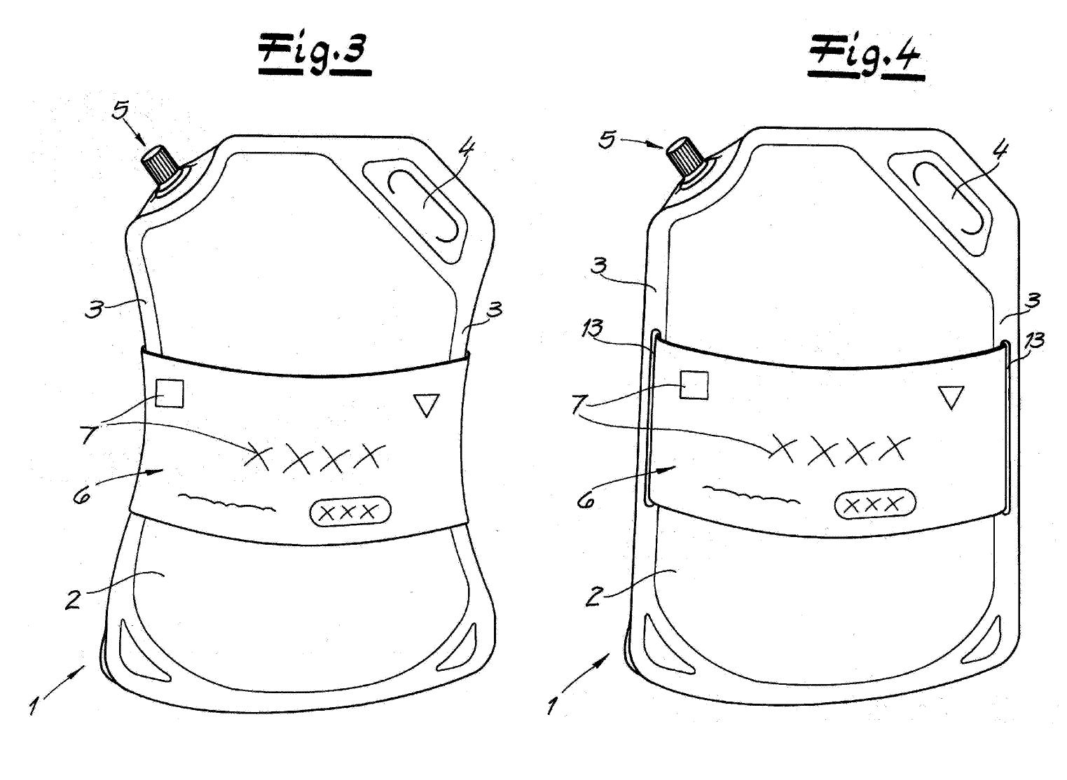

Alternatively, FIG. 3 shows a design in which the body 1 itself has a necking area of reduced cross section in the middle level with the separate piece 6 of label film so that the piece 6 of label film is then held permanently as a circumferential sleeve as a result of just the bag shape. In the context of such a design, the piece 6 of label film can then be easily pulled off the body 1 by a user in the form of a sleeve once the body 1 has been emptied. Complete separation also occurs during mechanical processing.

Based on this, FIG. 4 shows another variant in which the longitudinal welds 3 are furnished with slits 13 through which the piece 6 of label film extends in the manner of a sleeve. The necking area provided according to FIG. 3 is not necessary in this embodiment.

Further variants for attaching the piece 6 of label film to the body 1 are explained by FIGS. 5 and 6 where the basic shape of the piece 6 of label film and the body 1, as well as their proportions should thereby remain unchanged based on the previously described embodiments.

According to FIG. 5, the face panels 2 have openings 14 in central regions of the longitudinal weld 3. The piece 6 of label film is formed by a front and back piece that are attached to one another through the openings 14 so as to form a circumferential sleeve. The unattached side edges of the film pieces extend beyond the openings 14 and align roughly with the side edges of the body film 1.

According to a variant of this, the piece of label film is formed as a circumferential sleeve that encircles the body made from a single piece of label film, and the piece of label film is circumferentially sealed with a fin seal on one of the face panels that forms a back side. Alternatively, the piece of label film can also be circumferentially sealed using adhesive, for example. The actual attachment to the body is done here in that the face panels have openings in the longitudinal weld area, and the piece of label film designed according to FIG. 7 is welded to itself through these openings on its weldable layer. This also results in the benefit that the piece of label film does not need to be threaded through slits arranged in the longitudinal welds.

In a variant of this, FIG. 6 shows that a piece 6 of label film that predominantly only covers one of the two face panels 2 and can thus be provided in a simple manner. The edges of the piece 6 of label film then encircle the side edges and are fixed through the openings 14.

In a variant of this, the part of the piece of label film that encircles the side edge can also be replaced with another narrower film strip that does not cover the full width of the back panel, but rather only covers the opening 14 area. Sufficient attachment of a piece of label film applied to one side can likewise be ensured in this manner.

We claim:

1. A bag comprising:
front and back face panels formed of a body film and each having two generally parallel and normally vertical side edges bridging ends of respective upper and lower edges;
respective longitudinal side welds fixing the side edges of the front panel to the side edges of the back panel;
a separate piece of label film different from the body film, covering a mid portion of one of the face panels between the respective longitudinal edges, and spaced downward from the upper edge of the one face panel and upward from the lower edge of the one face panel; and
structure at the longitudinal edges holding the piece of label film on the one face panel without surface bonding of the piece of label film to the one face panel between the respective longitudinal edges.

2. The bag defined in claim 1, wherein the label film has a thickness between 20 μm and 170 μm, and the label film and body films have respective densities that differ by at least 0.02 g/cm³.

3. The bag defined in claim 1, wherein the label film has a thickness between 20 μm and 100 μm, and a ratio between a thickness of the body film and a thickness of the label film is larger than 3:2.

4. The bag defined in claim 3, wherein a ratio between a thickness of the body film and a thickness of the label film is larger than 2:1.

4. The bag defined in claim 1, wherein the piece of label film extends a full width of the one face panel between the longitudinal edges thereof.

5. The bag defined in claim 4, wherein the piece of label film is free of and not connected to the one face panel between the longitudinal edges thereof.

6. The bag defined in claim 1, wherein another such piece of label film different from the body film covers a mid portion of the other of the face panels between the respective longitudinal edges thereof, and is spaced downward from the upper edge of the other face panel and upward from the lower edge of the other face panel, the structure also holding the other piece on the other face panel without surface bonding and between the longitudinal edges thereof.

7. The bag defined in claim 1, wherein the piece of label film is fixed to the longitudinal welds.

8. The bag defined in claim 7, wherein the piece of label film is unitarily welded into the longitudinal welds.

9. The bag defined in claim 7, wherein the piece of label film is formed with a weakening line immediately adjacent and generally parallel to each of the longitudinal welds of the one face panel.

10. The bag defined in claim 1, wherein the face panels are joined so as to form a hermetically sealed interior.

11. The bag defined in claim 10, further comprising:
a resealable closure fixed to at least one of the face panels and opening into the interior.

12. The bag defined in claim 1, wherein the body film is a polyolefin and is devoid of printing.

13. The bag defined in claim 1, wherein the body film has a thickness between 125 μm and 250 μm.

14. The bag defined in claim 1, wherein the body film has a density between 0.89 g/cm³ and 0.95 g/cm³.

15. The bag defined in claim 1, wherein the label film has a density greater than 1 g/cm³.

16. The bag defined in claim 1, wherein the piece of label film is a laminate having an inner layer turned toward the one face film and an outer layer turned away from the face film, the printing being between the layers.

17. The bag defined in claim 16, wherein the inner layer is of polyolefin and weldable and the outer layer is of polyethyleneterephthalate.
